(19) United States
(12) Patent Application Publication
(10) Pub. No.: US 2006/0294195 A1
(43) Pub. Date: Dec. 28, 2006

(54) Multi-media message instant send

(75) Inventor: Edward Craig Hyatt, Durham, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communcations AB

(21) Appl. No.: 11/165,521

(22) Filed: Jun. 23, 2005

(51) Int. Cl. G06F 15/16

(52) U.S. Cl. 709/217

(57) ABSTRACT

The present invention describes a method and apparatus for instantly sending active media files from a mobile terminal to a remote device. According to the present invention, a mobile terminal stores a user-defined instant send address in memory of the mobile terminal. The stored instant send address represents an address, such as an email address, phone number, etc., associated with an instant send function of the mobile terminal. After activating a media file by, for example, taking a photograph, recording an audio message, recording video footage, drafting a text message, etc., the mobile terminal automatically sends the active media file to the stored instant send address when the user activates the instant send function.

### BACKGROUND

This invention relates generally to wireless communications and more particularly to media files transmitted from a mobile terminal.

Mobile terminals, such as cellular telephones, portable data assistants, and the like have become ubiquitous over the past few years. This is partly because of the size reduction and the increased functionality of most mobile terminals. For example, in addition to the conventional phone communications, newer mobile terminals offer consumers the option of sending and/or storing media files, such as text files, audio files, videos, photographs, etc., to a remote terminal. However, the user must navigate a complex system of menus and sub-menus to access the tools, such as an email interface, MMS (Multi-Media System) interface, and/or address book, required for sending the media file. Such navigation may be cumbersome, especially when a user repeatedly sends multiple media files to the same address.

### SUMMARY

The present invention comprises a method and apparatus for instantly sending active media files from a mobile terminal to a remote device. A mobile terminal of the present invention automatically sends an active media file to a predetermined user-defined address when the user activates an instant send function.

An exemplary method of the present invention comprises storing a user-defined instant send address in the mobile terminal's memory. The stored instant send address represents a remote terminal's address, such as an email address, phone number, etc., associated with an instant send function of the mobile terminal. After activating a media file by, for example, taking a photograph, recording an audio message, retrieving a video file, drafting a text message, etc., the mobile terminal automatically sends the active media file to the stored instant send address when the user activates the instant send function.

An exemplary mobile terminal of the present invention comprises memory and a transceiver circuit. The memory stores the user-defined instant send address, while the transceiver circuit automatically sends the active media file to the stored instant send address when the user activates the instant send function

### BRIEF DESCRIPTION OF THE DRAWINGS

FIG. 1 illustrates a block diagram of one exemplary mobile terminal according to the present invention.

FIG. 2 illustrates one exemplary method for implementing the present invention.

FIGS. 3A and 3B illustrate exemplary mobile terminals according to the present invention.

### DETAILED DESCRIPTION

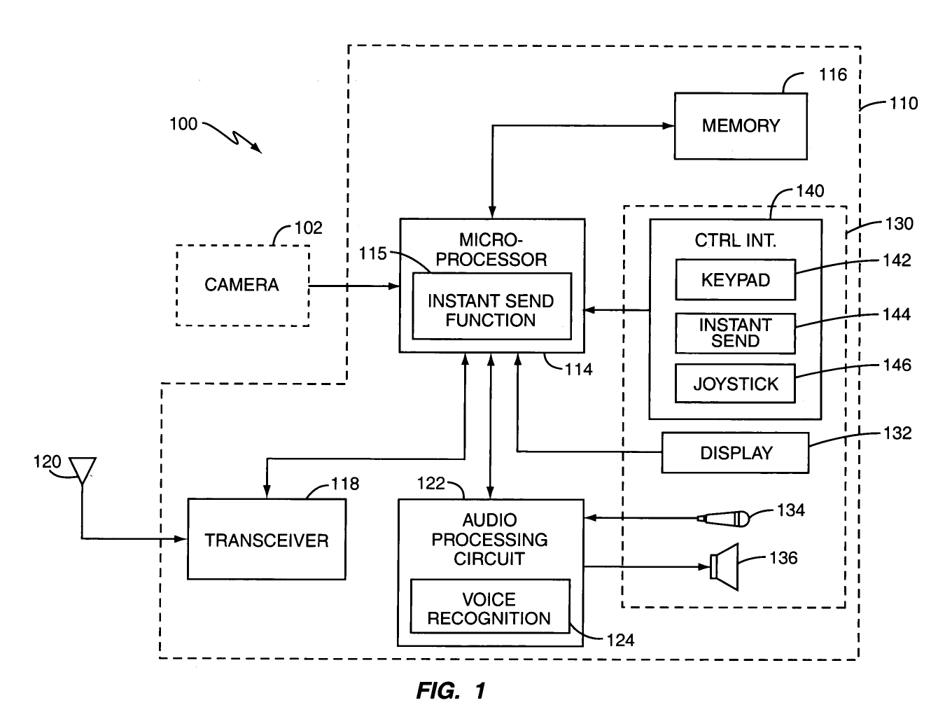

FIG. 1 illustrates a block diagram of one exemplary mobile terminal 100 according to the present invention. As used herein, the term “mobile terminal” may include a cellular radiotelephone; a Personal Communication System (PCS) terminal that may combine a cellular radiotelephone with data processing, facsimile, and data communications capabilities; a Personal Digital Assistant (PDA) that can include a radiotelephone, pager, Internet/intranet access, web browser, organizer, calendar, and/or a global positioning system (GPS) receiver; and a conventional laptop and/or palmtop receiver or other appliance that includes a radiotelephone transceiver capable of sending a Multi-Media System (MMS) message to a remote device.

Mobile terminal 100 comprises a communication circuit 110, and an optional camera circuit 102. Communication circuit 110 communicates with remote devices over a wireless network according to any known means. Camera circuit 102 captures and processes still and moving images for subsequent storage in memory 116, output to a display 132, and/or transmission by communication circuit 110. Because camera circuits 102 in mobile terminals are well understood in the art, they are not discussed further herein.

Communication circuit 110 comprises a microprocessor 114, memory 116, transceiver 118, audio processing circuit 122, and user interface 130. Microprocessor 114 controls the operation of mobile terminal 100 according to programs stored in memory 116, and may be implemented in a single microprocessor, or in multiple microprocessors. Suitable microprocessors may include, for example, both general purpose and special purpose microprocessors and digital signal processors. Microprocessor 114 may include an instant send function 115 for implementing the instant send feature of the present invention, as described further below. While FIG. 1 shows that the instant send function 115 is part of microprocessor 114, it will be appreciated that the instant send function 115 may be implemented in a separate processor.

Memory 116 represents the entire hierarchy of memory in a mobile terminal 100, and may include both random access memory (RAM) and read-only memory (ROM). Computer program instructions and data required for mobile terminal operation are stored in non-volatile memory, such as EPROM, EEPROM, and/or flash memory, which may be implemented as discrete devices, stacked devices, etc. In addition, memory 116 may include any mass storage, such as a memory stick, hard drive, optical drive, etc.

Transceiver 118 receives and transmits information via antenna 120. Such information may include, but is not limited to, text, image, and/or audio information. Transceiver 118 is a fully functional cellular radio transceiver, which may operate according to any known standard, including the standards known generally as the Global System for Mobile Communications (GSM), TIA/EIA-136, cdmaOne, cdma2000, UMTS, and Wideband CDMA. Because using mobile terminals to transmit and receive information is well understood, it will not be discussed further herein.

User interface 130 includes display 132, microphone 134, speaker 136, and control interface 140 that enable a user to interact with mobile terminal 100. Display 132 allows the operator to view information, such as menus, status information, still or video images, and application data. Control interface 140 allows the operator to navigate through menus, select menu options, input data, and control operation of the mobile terminal 100. To that end, control interface 140 may include a keypad 142, such as an alphanumeric keypad, and/or a navigation control, such as joystick control 146. In addition, control interface 140 may include volume controls, soft key controls, camera controls, full keyboard, etc. Microphone 134 converts the user's speech into electrical audio signals and speaker 136 converts audio signals into audible signals that can be heard by the user. Audio processing circuit 122 provides basic analog output signals to speaker 136 and accepts analog audio inputs from microphone 134. Further, audio processing circuit 122 may include a voice recognition circuit 124 to process voice commands according to any known means.

Mobile terminals 100 typically include applications that allow a user to receive, create, and/or store media files. As used herein, the term “media file” refers to any data file provided by the user and/or accessible by the user. Media files may be stored in memory 116. Exemplary media files include, but are not limited to, still or moving images, email messages, text files, and/or audio files. Frequently, a user will want to share a media file with another party. However, conventional mobile terminals do not provide a convenient way to share media files without navigating through a cumbersome user interface and entering address information. The cumbersome nature of the user interface often discourages sharing the media files.

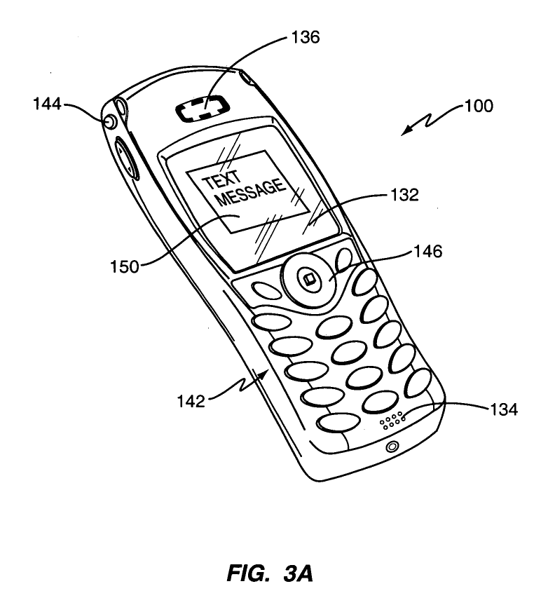

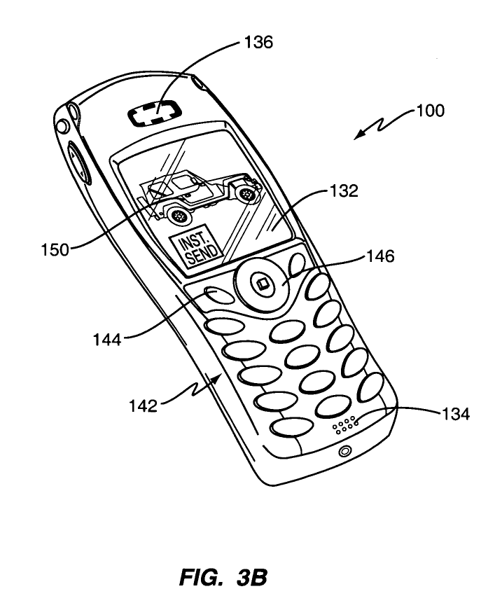

The present invention provides a convenient method and apparatus for sending a media file to a pre-selected remote device. According to the present invention, mobile terminal 100 automatically sends an active media file 150 to a predefined instant send address responsive to user activation of an instant send function 115. A user inputs an instant send address and stores the address in memory 116. The instant send address may comprise any type of communication address, i.e., an email address, phone number, uniform resource locator (URL), etc. The instant send address serves as a default address for the instant send function 115. As used herein, the term “active media file” refers to any media file currently being input by the user, output to the user, or otherwise accessed by the user. For example, a still image displayed on display 132, as shown in FIG. 3B, represents an active media file 150. Similarly, a text message displayed on display 132, as shown in FIG. 3A, represents an active media file 150. In addition, a current email message, a photograph retrieved from memory 116, a recently recorded audio file, etc., represent different types of active media files 150.

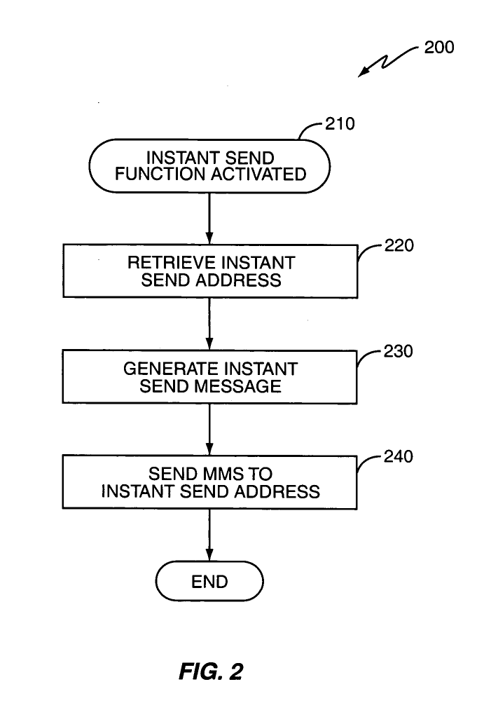

FIG. 2 illustrates one exemplary instant send method 200 of the present invention. To implement the present invention, the user activates the instant send function 115 (block 210). The user may activate the instant send function 115 by any known means. According to one embodiment of the present invention, control interface 140 may include an instant send control 144 for activating the instant send function 115. Instant send control 144 may comprise a control button 144 disposed on the mobile terminal 100. For example, as shown in FIG. 3A, instant send control 144 may comprise a control button 144 disposed on a side of mobile terminal 100. Alternatively, instant send control 144 may comprise a soft key 144, as shown in FIG. 3B. In still another embodiment, the instant send control 144 may comprise a voice recognition circuit 124 that implements a voice recognition function. The voice recognition function activates the instant send function 115 responsive to an instant send voice command from the user.

After activating the instant send function 115 (block 210), mobile terminal 100 retrieves the instant send address (block 220) and automatically generates an instant send message based on the currently active media file 150 (block 230). Depending on the type of the active media file 150, mobile terminal 100 formats the instant send message according to any known message format, i.e., MMS, SMS (Short-Message Service), email, voice, etc. Subsequently, mobile terminal 100 automatically sends the instant send message to the retrieved instant send address (block 240)

The above describes the present invention in terms of a single instant send address designated by the user. However, the present invention is not so limited. According to one exemplary embodiment, a user may designate and store a different instant send address for each of one or more different types of media. When the user activates the instant send function 115, the transceiver 118 automatically sends the active media file 150 to the instant send address designated for the type of media file corresponding to the active media file 150. For example, the user may store a friend's email address for text messages, a work number for audio files, a home email address for photographs, etc. Therefore, when the active media file 150 is a photograph, activation of the instant send function 115 causes transceiver 118 to automatically send the active media file 150 (photograph) to the home email address.

According to another exemplary embodiment, a user may designate and store a different instant send address for different mobile terminal applications. When the user activates the instant send function 115, the transceiver 118 automatically sends the active media file 150 to the address designated for the current application. For example, the user may store a friend's email address for email applications, a work number for audio recording applications, a home email address for camera applications, etc. Therefore, when using the camera 102, activation of the instant send function 115 causes transceiver 118 to automatically send the active media file 150 to the home email address.

The invention described above provides advantages to both the user and the network providers. Because the user pre-programs the instant send address in mobile terminal 100, the user can send an active media file 150 to the instant send address without having to navigate a system of menus and submenus. As a result, users can quickly and easily send photographs, audio files, etc. In addition, because the mobile terminal 100 solely manages the instant send function 115, the present invention does not require any changes to the network.

The above describes the present invention in terms of a mobile device made of separate devices, i.e., microprocessor, 114, memory 116, transceiver 118, etc. However, it will be appreciated that one or more of the devices in communication circuit 110 may be incorporated into a specially designed application-specific integrated circuit (ASIC). In addition, the present invention may be embodied in hardware and/or in software (including firmware, resident software, micro-code, etc.), including an ASIC. Furthermore, the present invention may take the form of a computer program product on a computer-usable or computer-readable storage medium having computer usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, or a portable compact disc read-only memory (CD-ROM). Note that the computer-usable or computer-readable medium could even be paper or another suitable medium upon which the program is printed, as the program can be electronically captured via, for example, optical scanning or the paper or other medium, then compiled, interpreted, or otherwise processed in a suitable manner, if necessary, and then stored in a computer memory.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

We claim:

1. A mobile terminal comprising:
memory configured to store a user-defined instant send address; and
a transceiver circuit configured to automatically send an active media file to the instant send address responsive to user activation of an instant send function.

2. The mobile terminal of claim 1 wherein the memory is configured to store different instant send addresses for different types of media files.

3. The mobile terminal of claim 2 wherein the transceiver circuit is configured to automatically send the active media file to the instant send address corresponding to a media type of the active media file.

4. The mobile terminal of claim 1 wherein the memory is configured to store different instant send addresses for different mobile terminal applications.

5. The mobile terminal of claim 4 wherein the transceiver circuit is configured to automatically send the active media file to the instant send address corresponding to a current mobile terminal application.

6. The mobile terminal of claim 1 further comprising an instant send control operatively connected to the transceiver circuit, wherein user activation of the instant send control activates the instant send function.

7. The mobile terminal of claim 6 wherein the instant send control comprises one of a control button and a soft key disposed on the mobile terminal.

8. The mobile terminal of claim 6 wherein the instant send control comprises a voice recognition circuit configured to recognize an instant send voice command from a user.

9. The mobile terminal of claim 1 wherein the active media file comprises at least one of an active image, text file, video file, and audio media file.

10. The mobile terminal of claim 1 wherein the user-defined instant send address comprises at least one of an email address, a phone number, and a uniform resource locator.

11. The mobile terminal of claim 1 wherein the mobile terminal comprises a cellular telephone.

12. A method of automatically sending a multi-media message from a mobile terminal, the method comprising:
storing a user-defined instant send address in a memory of the mobile terminal; and
automatically sending an active media file to the instant send address responsive to user activation of an instant send function.

13. The method of claim 12 wherein storing a user-defined instant send address comprises storing different instant send addresses for different types of media files.

14. The method of claim 13 wherein automatically sending the active media file comprises automatically sending the active media file to the instant send address corresponding to a media type of the active media file.

15. The method of claim 12 wherein storing a user-defined instant send address comprises storing different instant send addresses for different mobile terminal applications.

16. The method of claim 15 wherein automatically sending the active media file comprises automatically sending the active media file to the instant send address corresponding to a current mobile terminal application.

17. The method of claim 12 wherein the activate media file comprises an output media file currently output to a user.

18. The method of claim 17 wherein the output media file comprises at least one of a text file, image file, video file, and audio file output to the user.

19. The method of claim 12 wherein the activate media file comprises an input media file currently input to the mobile terminal.

20. The method of claim 19 wherein the input media file comprises least one of a currently recorded image and recorded audio file.

21. The method of claim 12 wherein automatically sending the active media file comprises automatically sending at least one of an active text, image, video, and audio file.

22. The method of claim 12 wherein storing a user-defined instant send address comprises storing at least one of an email address, a phone number, and a uniform resource locator.

23. The method of claim 12 further comprising activating the instant send function by activating an instant send control associated with the mobile terminal.
